(19) United States
(12) Patent Application Publication
(10) Pub. No.: US 2004/0057115 A1
(43) Pub. Date: Mar. 25, 2004

(54) Optical device

(75) Inventors: Yujin Yamazaki, Kawasaki (JP); Yuichi Kawahata, Kawasaki (JP); Nobuaki Mitamura, Sapporo (JP); Hirohiko Sonoda, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/665,346

(22) Filed: Sep. 22, 2003

(30) Foreign Application Priority Data
Sep. 25, 2002 (JP) 2002-279989

(51) Int. Cl. G02B 27/00

(52) U.S. Cl. 359/577

(57) ABSTRACT

A stress correction film is applied to one side of a VIPA optical element provided with a multi-layer fully reflective film and an anti-reflective film on one surface of a transparent plate, and a semi-transparent multi-layer reflective film on the other surface, in order to adjust the unbalance between the respective stress of the multi-layer films on each surface. In other words, by applying a stress correction film, the unbalance between the respective stress of the multi-layer films on each surface of the VIPA optical element is corrected, and accordingly a VIPA optical element with low profile irregularity can be realized.

### BACKGROUND OF THE INVENTION

1. Field of the Invention

The present invention relates to an optical device configured so as to maintain the best possible optical characteristic of an optical element. More specifically, it relates to an optical device configured so as to suppress the degradation due to the deformation of a VIPA optical element in the optical characteristic of a virtually-imaged phased array (VIPA) optical element of an optical device using it in order to cause wavelength dispersion.

2. Description of the Related Art

In the conventional optical fiber communication system for optically transmitting information, a transmitter transmits optical pulses to a receiver through an optical fiber. However, the wavelength dispersion in the optical fiber, which is also called “chromatic dispersion”, degrades the quality of signals in the system.

More specifically, the result of wavelength dispersion shows that the transmission speed of signal light in an optical fiber depends on the wavelength of the signal light. For example, if an optical pulse with a long wavelength (for example, an optical pulse with a wavelength indicating red color) propagates faster than that with a short wavelength (for example, an optical pulse with a wavelength indicating blue color), such dispersion is called “normal dispersion”. Conversely, if an optical pulse with a short wavelength (for example, a blue color pulse) propagates faster than that a long wavelength (for example, a red color pulse), such dispersion is called “abnormal dispersion”.

Therefore, if signal light that is transmitted from a transmitter consists of a red pulse and a blue pulse, the signal pulse is divided into the red pulse and the blue pulse while it propagates through the optical fiber, and they are received by the receiver at different times.

If, as another example of optical pulse transmission, a signal light pulse with a wavelength component which is continuous from a red color to a blue color is transmitted, the propagation time of the signal light pulse in the optical fiber prolongs and distortion occurs in the signal light pulse since each component propagates through the optical fiber at a different speed. Since each pulse consists of a limited number of wavelength components in a specific wavelength range, such wavelength dispersion is very popular in an optical fiber communication system.

Therefore, particularly, in a high-speed optical fiber communication system, it is necessary to compensate for wavelength dispersion in order to secure a high transmission capacity.

In order to compensate for such wavelength dispersion, a reciprocal dispersion component that provides wavelength dispersion the reverse of wavelength dispersion caused in an optical fiber, is needed in an optical fiber communication system.

Such a reciprocal dispersion component is proposed in Japanese Patent Application Nos. 10-534450 and 11-513133. It comprises an optical device, including an optical element called a “virtually imaged phased array (VIPA)”.

FIGS. 1 through 3 show a VIPA and a reciprocal dispersion component using the VIPA.

A VIPA optical element makes a plurality of segments of input light interfere with itself and generates light to be transmitted from the VIPA optical element. A dispersion compensation device that acts as a reciprocal dispersion component using a VIPA optical element, comprises a light returning device returning light to the VIPA optical element and causing multi-reflection in the VIPA optical element.

The optical device, being a dispersion compensator, receives input light of a specific wavelength within a continuous wavelength range and generates output lights within a continuous wavelength range each corresponding to each component included in the input light. This output light can be spatially distinguished from an output light of another wavelength within the continuous wavelength range (for example, propagating in a different direction). If this output light can be distinguished from another segment of output light by a propagation angle, it can be said that this optical device has “angular dispersion”.

A VIPA optical element comprises a transmission area and a transparent plate. Light can transmit into/out of the VIPA optical element through the transmission area. The transparent plate contains the first and second surfaces.

The first and second surfaces are reflectors. The reflector on the second surface is semi-transparent, and has both a reflective characteristic and a characteristic of transmitting part of the input light. This reflector can be generally obtained by forming a transparent dielectric multi-layer film on the transparent plate. However, the first surface reflector is a fully reflective film that reflects the entire input light. Although the fully reflective film on the first surface is also a multi-layer film, the number of layers of this multi-layer fully reflective film is larger than that of the semi-transparent multi-layer film on the second surface. Input light is received by the VIPA optical element through the transmission area and is reflected on the first and second surfaces of the transparent plate many times. Therefore, a plurality of segments of light transmits through the second surface. The plurality of segments of transmission light interfere with each other and a plurality of segments of output light each of which propagates in a different direction depending on its wavelength, is generated.

Input light has a specific wavelength within a continuous wavelength range and output light can be spatially distinguished from another segment of light with other wavelengths in the wavelength range. The light returning device can return the output light to the second surface in the completely opposite direction. Then, this plurality of segments of returned light transmits through the second surface and is inputted into the VIPA optical element. Then, the plurality of segments of returned light is multiply reflected in the VIPA optical element and is outputted to the input path from the transmission area of the VIPA optical element.

The light returning device of the optical device returns output light in one order of interference of a plurality of segments of light each in a plurality of orders of interference that is outputted from the VIPA optical element, and does not return the other segments of output light each in other orders of interference, to the VIPA optical element. In other words, the light returning device returns only light corresponding to a specific order of interference to the VIPA optical element.

In this case, the light returning device comprises a reflection mirror. The surface shape of the mirror is formed in such a way that the optical device causes specific wavelength dispersion.

As described above, the VIPA optical element has an angular dispersion function like a diffraction grading and can compensate for wavelength dispersion. In particular, the VIPA is characterized by large angular dispersion and can easily make a practical reciprocal dispersion component.

As shown in FIG. 1, light inputted from an input fiber is forwarded to a collimation lens 11 by an optical circulator 10. The collimation lens 11 converts light that spreads and propagates from the output port of the optical fiber, into parallel light. After transmitting through the transmission area of a VIPA optical element 13, the plurality of segments of light that is paralleled by the collimation lens 11, is focused in a line in the VIPA optical element.

The light focused in a line is reflected off the reflective films provided on the surface of the VIPA optical element 13 many times. Since one of the reflective films is semi-transparent, part of the light is outputted little by little to a focus lens 14 while the reflection is repeated many times. A plurality of segments of light that is outputted while the reflection is repeated, interferes with each other and forms a plurality of segments of luminous flux with a different propagation direction each depending on wavelength. The focus lens 14 focuses the plurality of segments of light flux on a specific position on the surface of the reflection mirror 15. The plurality of segments of light reflected by the reflection mirror 15 is inputted to the VIPA optical element 13 again through the focus lens 14. The plurality of segments of light inputted to the VIPA optical element 13 again in this way, is outputted from the transmission area of the VIPA optical element 13 after repeating multi-reflection. Then, the plurality of segments of light is inputted to the optical fiber through a line focus lens 12 and a collimation lens 11 and is combined there. The plurality of segments of light inputted to the optical fiber is outputted from an output fiber through the optical circulator 10.

FIG. 2 shows how the VIPA optical element generates output light.

A plurality of segments of light focused in a line is inputted to the VIPA optical element from a line focus lens through the transmission area provided with an anti-reflective film. The plurality of segments of input light is multiply reflected in the VIPA optical element. However, if this bent and folded reflection light route is expanded, it becomes a virtually imaged phased array. Therefore, the plurality of segments of light outputted from a virtual image interferes with itself and is reinforced by the interference. Then, a plurality of segments of light is generated on a semi-transparent multi-layer reflective film and is outputted. Although the plurality of segments of light generated by this interference propagates in a direction where the constructive interference conditions are met. Since the constructive interference conditions vary depending on wavelength, a plurality of segments of luminous flux is generated in different directions for each wavelength. Therefore, the VIPA optical element shown in FIG. 1 corresponds to a diffraction grating with a large diffraction order, and each segment of output light propagates in a direction where the constructive interference conditions are met.

FIG. 3 shows the principle of wavelength dispersion compensation using the VIPA optical element.

As shown in FIG. 3, each segment of light focused on a reflection mirror located after a focus lens is returned to an arbitrary position according to a reflection angle determined by the shape of a focus position of the reflection mirror and is inputted to the optical fiber again on a route the reverse of that taken when it is first inputted to the optical fiber and is combined there. If as shown in FIG. 3, the reflection mirror is convex, light with a short wavelength is returned to an upper beam image, and its optical path length becomes greater than that of light with a long wavelength, and its delay increases. Therefore, in this case, the dispersion compensator can cause negative dispersion. Conversely, if the reflection mirror is concave, the dispersion compensator can cause positive dispersion. Since a dispersion compensator using the VIPA optical element is configured in such a way that when returning, light takes the same optical path as that taken when propagating, the dispersion compensator can be used in line by using a circulator.

However, if in an optical device using the VIPA optical element in order to compensate for wavelength dispersion, the VIPA optical element made of a transparent plate bends and its profile irregularity degrades, the periodicity of a virtually imaged phased array is destroyed, and the degradation of the optical characteristic, such as the increase of insertion loss, the decrease of transmission band and the like, of the device is caused. Although in reality the VIPA optical element is obtained by forming a plurality of multi-layer reflective films each with a different number of layers on each surface of the transparent plate by an ionization film forming method, such as an ion plating method and the like, each film constituting the multi-layer film is stressed. Therefore, the multi-layer film also exhibits film stress, the magnitude of which depends on the number of layers, and the transparent plate bends due to the unbalanced film stress between each surface, which is a problem.

There is another problem, in which the VIPA optical element is easy to bend when it is fixed. If its fixing method is inappropriate, the VIPA optical element also bends when environmental temperature changes, which is another problem.

In particular, the thickness of the transparent plate is designed to meet the following conditions on “the FSR thickness of WDM matching” in order to simultaneously compensate for dispersion in each channel.

2nt cos θ=mλ (1)

FSR=c/2nt cosθ (2)

(n, t, θ, FSR and c represent the refractive index of lass, the physical thickness of glass, the luminous flux propagation direction of the center wavelength λ of each channel and the tilt angle of the optical axis of input light, the interval of the center wavelength between channels and luminous flux, respectively) Therefore, in order to simultaneously give the same wavelength dispersion to all the channels of multi-wavelength light with, for example, a 200 GHz interval, the thickness of the transparent plate must be 0.5 mm when the refractive index of the transparent plate n is 1.5, which is relatively thin. If the transparent plate is thin in this way, the degradation of the optical characteristic due to the bending described above increases.

In a device using the VIPA optical element in order to compensate for wavelength dispersion, a means for maintaining the optical characteristic of the device by fixing the VIPA optical element, maintaining its profile irregularity and preventing it from bending, must be provided.

### SUMMARY OF THE INVENTION

It is an object of the present invention to provide an optical device configured so as to avoid the deformation of the optical element and the degradation due to it of the optical characteristic of the device.

An optical device according to the present invention comprises: a substrate; a first multi-layer film with a first refractive index, that is formed on a first surface of the substrate; a second multi-layer film with a second refractive index, that is formed on a second surface of the substrate; and a stress correction film formed on the first or second multi-layer film, correcting the distortion of the substrate that is due to the difference in stress between the first and second multi-layer films formed on the first and second films, respectively.

According to the present invention, an optical apparatus which has good optical characteristics by effectively correcting deformation of an optical element which occurs due to a difference of stresses in multi-layered films provided on both surfaces of a substrate of the optical element, is provided.

### BRIEF DESCRIPTION OF THE DRAWINGS

FIG. 1 shows a VIPA and a reciprocal dispersion component using the VIPA (No. 1);

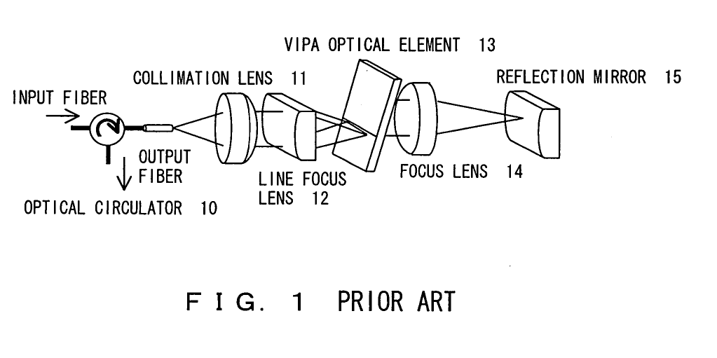

FIG. 2 shows a VIPA and a reciprocal dispersion component using the VIPA (No. 2);

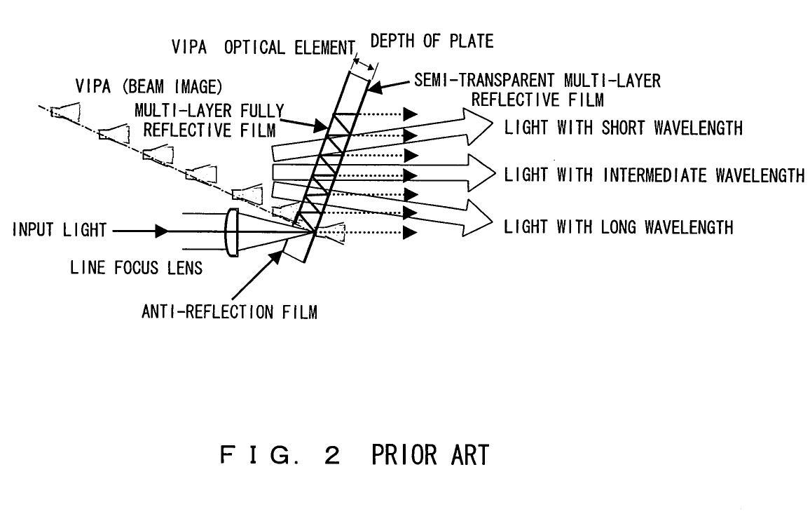

FIG. 3 shows a VIPA and a reciprocal dispersion component using the VIPA (No. 3);

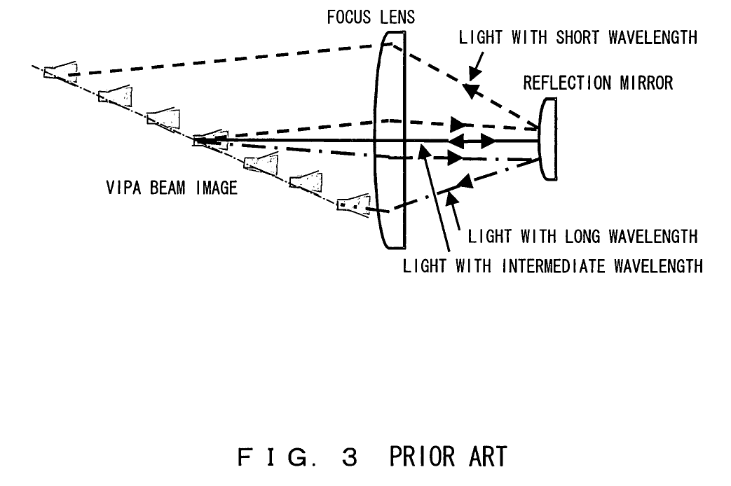

FIG. 4 shows the structural problems of a VIPA optical element and the configuration of its preferred embodiment (No. 1);

FIG. 5 shows the structural problems of a VIPA optical element and the configuration of its preferred embodiment (No. 2);

FIG. 6 shows the thickness of a stress correction film;

FIGS. 7A and 7B are the top view and section view, respectively, of the fixed VIPA optical element;

FIGS. 8A and 8B show another method for fixing the VIPA optical element on fixing material according to the preferred embodiment of the present invention;

FIG. 9 compares the optical characteristics that show the effects of the preferred embodiment (No. 1);

FIG. 10 compares the optical characteristics that show the effects of the preferred embodiment (No. 2);

FIG. 11 compares the optical characteristics that show the effects of the preferred embodiment (No. 3); and

FIGS. 12A and 12B show the structure of another preferred embodiment of the present invention.

### DESCRIPTION OF THE PREFERRED EMBODIMENTS

The preferred embodiment of the present invention comprises a flat optical element, in which the film stress on each surface is balanced by using a multi-layer fully reflective film on one surface of the focused light receiving transparent plate, and a semi-transparent multi-layer reflective film and a transparent film for correcting stress on the other surface; and a mirror reflecting and returning the spectral components of light separated by the optical element to the optical element. The optical film thickness of the transparent film that corrects the stress is an integral multiple of half a wavelength. In particular, the material of the transparent film that corrects the stress is SiO₂. Furthermore, the profile irregularity of the effective surface of the flat optical element, in which the film stress on each surface is balanced, is one wavelength or less.

Or, in the preferred embodiment of the present invention, an optical element is provided with flat surfaces balancing film-stresses on both sides by having a multi-layered full reflection film on one side of the transparent plate where focused light enters and having, on another side, a semi-transparent multi-layered reflection film and a transparent film which corrects stresses, the optical element being attached on a plane of a fixing material having approximately equal expandability with the transparent plate so that flatness is maintained regardless of temperature change, and also a mirror is provided reflecting light, which is broken down into a spectrum by the optical element, back to the optical element. The fixing material having almost the same thermal expansion coefficient as the transparent plate shall be made of transparent glass or semi-conductor. Furthermore, alternatively, the fixing material having almost the same thermal expansion coefficient as the transparent plate can be made of opaque metal or opaque ceramic metal. The opaque fixing material having almost the same thermal expansion coefficient as the transparent plate shall be made of copper-tungsten alloy, Kovar alloy, alumina or BeO. The optical element on the plane surface of the fixing material having almost the same thermal expansion coefficient as the transparent plate can be fixed by organic adhesives fixing, metallic soldering fixing or low-melting point glass fixing.

The optical element on the plane surface of the fixing material having almost the same thermal expansion coefficient as the transparent plate can be fixed by multi-point fixing. Alternatively, the optical element on the glass plane surface having almost the same thermal expansion coefficient as the transparent glass plate can be fixed by optical junction fixing. The material used for the optical junction surface of a glass plane, having almost the same thermal expansion coefficient as the transparent glass plate, is SiO₂.

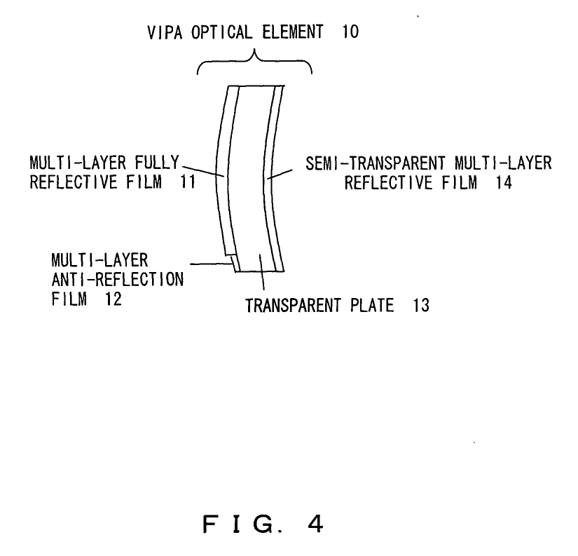

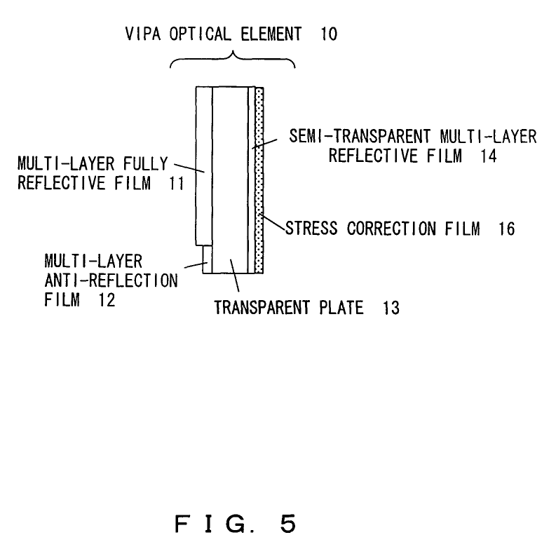

FIGS. 4 and 5 are section views showing the structural problems of the VIPA optical element and the structure of the preferred embodiment.

The VIPA optical element 10 comprises a transparent plate 13, a multi-layer fully reflective film 11 formed on one surface of the transparent plate 13, a multi-layer anti-reflective film 12 formed on part of the same surface as the multi-layer fully reflective film 11 and a semi-transparent multi-layer reflective film 14 formed on the other surface of the transparent plate 13.

In this preferred embodiment, for the transparent plate, transparent optical glass (LAH78: made by Ohara, n=1.86) is used and in order to meet FSR=200 GHz, its thickness t is 0.4 mm.

In this preferred embodiment, the multi-layer fully reflective film 11, the semi-transparent multi-layer reflective film 14 and the multi-layer anti-reflective film 12 are all made of a multi-layer conductive film consisting of an SiO₂ film and a TiO₂ film, and is formed by an ion plating method. It is preferable for the boundary between the multi-layer fully reflective film 11 and the multi-layer anti-reflective film 12 to be as narrow as possible in order to reduce insertion loss. The films are patternized by a lift-off method using a mask and a resist.

In this preferred embodiment, the refractive indexes of the multi-layer fully reflective film 11, the semi-transparent multi-layer reflective film 14 and the multi-layer anti-reflective film 12 are 99.9%, 98% and 0.25%, respectively. The number of layers of the multi-layer fully reflective film 11, the semi-transparent multi-layer reflective film 14 and the multi-layer anti-reflective film 12 is 21, 11 and 41 respectively.

In this case, since the SiO₂ film formed by an ion plating method has strong compressive stress and a TiO₂ film has weak pulling stress, the multi-layer film has compressive stress as a whole. Since the degree of the film stress is proportional to the number of layers, the film stress of a multi-layer fully reflective film with the larger number of layers overpowers the film stress of the semi-transparent multi-layer reflective film. As a result, the VIPA optical element 10 bends in such a way that the multi-layer fully reflective film may be outwardly convex, as shown in FIG. 4.

In order to cope with this phenomenon, in this preferred embodiment, a stress correction film 16 made of an SiO₂ film with compressive stress is formed on the semi-transparent multi-layer reflective film 14, as shown in FIG. 5. In this preferred embodiment, when the optical film thickness of the SiO₂ film is four times a semi-wavelength (4λ/2=2λ:λ=1,550 nm), the film stress of each surface is well balanced and its profile irregularity decreases to λ/2 or less. It is preferable for the profile irregularity to be λ or less, and more preferable for it to be λ/2 or less. In this case, since the optical film thickness of the SiO₂ film is an integral multiple of a semi-wavelength, the refractive index of the semi-transparent multi-layer reflective film does not change. Since the refractive index of the semi-transparent multi-layer reflective film greatly affects the optical characteristic of the VIPA optical element, it is preferable for the optical film thickness of the stress correction film 16 to be an integral multiple of a semi-wavelength.

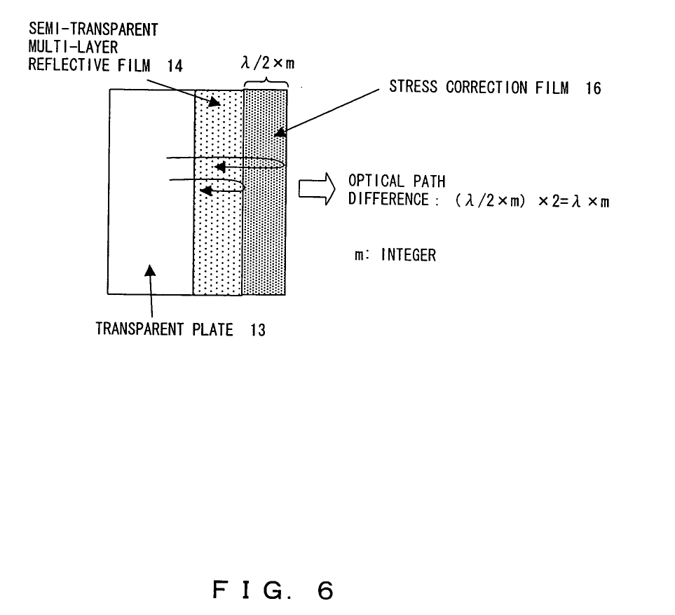

FIG. 6 shows the thickness of the stress correction film.

If the optical film thickness of the stress correction film 16 is an integral multiple of a semi-wavelength, the optical path difference of light reflected on a boundary surface between the stress correction film 16 and the semi-transparent multi-layer reflective film 14 becomes twice the film thickness of the stress correction film 16, that is, an integral multiple of one wavelength. The fact is expressed as (λ/2×m)×2=λ×m (m: integer). In this case, since there is no phase shift in each segment of reflection light, the refractive index of the semi-transparent multi-layer reflective film 14 is not affected.

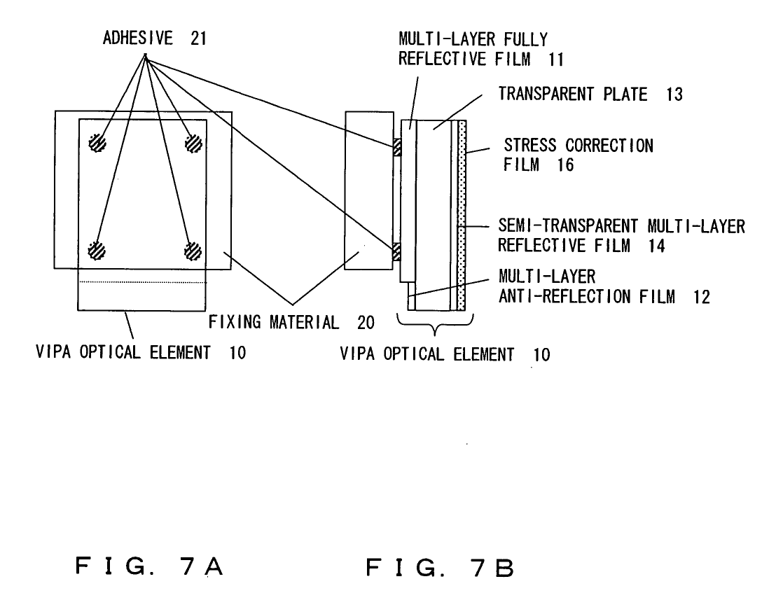

Next, the structure of the present invention obtained by fixing the flat VIPA optical element, in which the film stress on each surface is balanced by a stress correction film, to the fixing material, is described with reference to FIGS. 7A and 7B.

FIGS. 7A and 7B are the top view and section view of the fixed VIPA optical element, respectively.

In this preferred embodiment, the multi-layer fully reflective film 11 side of the VIPA optical element is fixed on the plane surface of a plate-shaped fixing material 20 at four points. In this preferred embodiment, for the plate-shaped fixing material 20, a copper-tungsten alloy having almost the same thermal expansion coefficient (Cu:W=92:8, thermal expansion coefficient α=6.0×10⁻⁶) as the transparent plate (LAH78, thermal expansion coefficient (α=6×10⁻⁶) is used. The profile irregularity of the plate is low and is λ or less. Since the copper-tungsten alloy constituting the fixing material 20 is opaque, as shown in FIG. 7, the light input portion of the VIPA optical element (which corresponds to a portion on which the anti-reflective film is formed) projects from the opaque plate made of copper-tungsten alloy. Although the multi-layer fully reflective film 11 of the VIPA optical element faces against the opaque plate made of copper-tungsten alloy, light does not transmit from the multi-layer fully reflective film 11. Therefore, there is no problem in the optical characteristic of the optical element. It is preferable for the plate-shaped fixing material 20 made of copper-tungsten alloy to be sufficiently thick and therefore difficult to deform, in view of the fact that the fixing material 20 may also be fixed to another material.

In this preferred embodiment, for adhesive 21, thermosetting epoxy family organic adhesives with low thermosetting shrinkage are used. In this case, in order to unify the painted amount of adhesives, a dispenser controls the painted amount.

In this preferred embodiment, since the VIPA optical element is fixed at a plurality of points using the adhesive 21 with low thermosetting shrinkage, no stress is applied to the VIPA optical element 10. Therefore, the amount of change in the profile irregularity of the VIPA optical element after fixing is λ/10 or less, and almost the same profile irregularity can be maintained after fixing. Furthermore, since by fixing the VIPA optical element 10 at specific points to a plate having almost the same thermal expansion coefficient as the transparent plate 13, the VIPA optical element and the plate 13 simultaneously expand/shrink at the same rate when temperature changes, the VIPA optical element does not bend by temperature change. Therefore, even if the environmental temperature changes, the change in the profile irregularity of the VIPA optical element 10 is λ/10 or less and almost the same profile irregularity can be maintained in a wide range of environmental temperature.

A term “profile irregularity” is used to specify how close to its designed value a surface shape is. The profile irregularity is determined by comparing an actual surface with the test plate standard using the interference between them, and it is specified by the number of interference ring stripes and ring regularity. Since a helium neon laser (λ=632.8 nm) is used for a light source for interference, a wavelength λ used to describe profile irregularity is 682.8 nm. This wavelength is different from a wavelength λ=1,550 nm used for optical communication.

As a comparison target, the VIPA optical element is fixed on SUS 304 (thermal expansion coefficient α=18.7×10⁻⁶) with a thermal expansion coefficient larger than that of the transparent plate 13 using similar thermosetting organic adhesives, as the plate-shaped fixing material 20. In this case, thermal distortion occurs due to a change in temperature during hardening and the profile irregularity of the VIPA optical element changes by λ or more, causing the VIPA optical element to bend by λ or more. When environmental temperature changes, the profile irregularity of the VIPA optical element varies with the temperature.

Although in this preferred embodiment, a copper-tungsten alloy is used for the fixing material 20, another metal, such as a Kovar (Fe—Ni—Co) alloy (thermal expansion coefficient α=5.3×10⁻⁶), etc, and a ceramic, such as alumina (Al₂O₃: thermal expansion coefficient α=6.7×10⁻⁶), BeO (thermal expansion coefficient α=7.6×10⁻⁶), etc., or the like can also be used depending on the thermal expansion coefficient of the transparent plate 13 to be used. Although in this preferred embodiment, the VIPA optical element 10 is fixed on the plane surface of the plate-shaped fixing material 20, the fixing material 20 is not necessarily plate-shaped. Any shape can be used as long as the fixing material has a plane surface with a low profile irregularity. For the fixing material 20, the same transparent glass (in this preferred embodiment, LAH78) as the transparent material used, transparent glass having almost the same thermal expansion coefficient as the transparent material (for example, BSM14: thermal expansion coefficient α=6.0×10⁻⁶) or semiconductor, such as GaAs that is transparent in an infrared ray range (thermal expansion coefficient α=5.9×10⁻⁶), etc., whose thermal expansion coefficients are almost the same as the transparent material, can also be used.

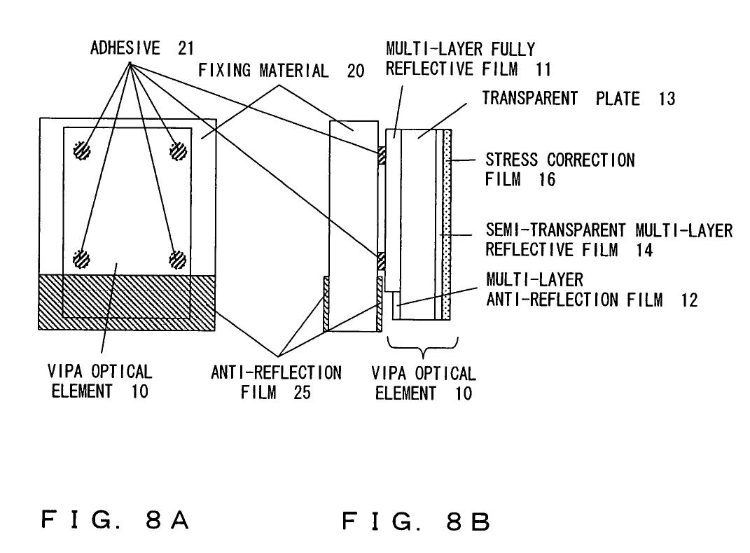

FIGS. 8A and 8B show a method for fixing the VIPA optical element on another fixing material according to the preferred embodiment of the present invention. FIGS. 8A and 8B are the top view and the section view, respectively.

If such a transparent fixing material 20 is used, it is not always necessary for the light input portion of the VIPA optical element to project from the fixing material 20 as in this preferred embodiment. There is no problem with the optical character of the optical element as long as , as shown in FIG. 8, an anti-reflective film 25 is formed in the position corresponding to the light input portion of the VIPA optical element.

Although in this preferred embodiment, for the adhesive 21, thermosetting organic adhesives are used, the VIPA optical element can also be fixed by other infrared ray thermosetting or anaerobic organic adhesives, metallic soldering using a Pb—Sn alloy, an Au-Sn alloy, etc. or low melting point glass of PbO—B₂O₃ family or Na₂O—BaO—SiO₂ family or the like.

A dispersion compensator (optical device) can be realized by using such a flat VIPA optical element 10 that is fixed on the plane surface of the fixing material 20 having almost the same thermal expansion coefficient as the transparent material, in which the film stress on each surface is balanced, and a mirror reflecting and returning the spectral components of light separated by the VIPA optical element 10 to the VIPA optical element 20.

As for the specific structure and material of the stress correction film 16, the material is SiO₂ and the film is made of a single SiO₂ layer. The film layer thickness is an integral multiple of half a wavelength. In this preferred embodiment, it is 2λ (λ=1,550 nm).

The SUS304 is austenite family stainless steel SUS304 [18% Cr-8% Ni] that is specified in JIS Standards (Specification No.: JISG4304).

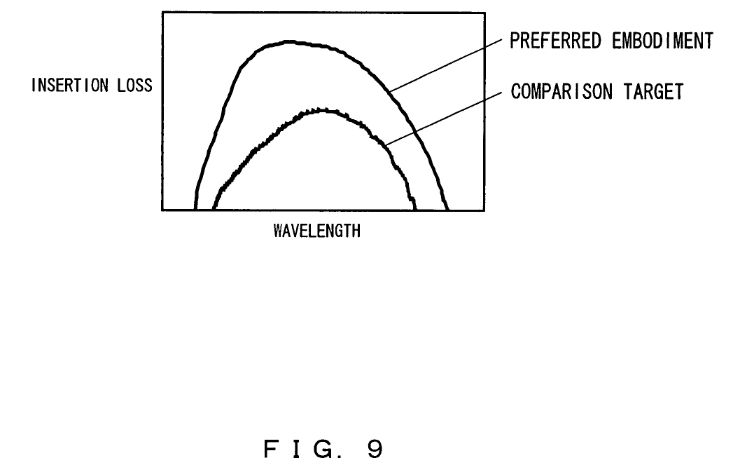

FIGS. 9 through 11 compare the optical characteristics that show the effect of the preferred embodiment.

When the optical characteristics of the dispersion compensator of the preferred embodiment have been checked, as a result, a transmission characteristic with both small insertion loss and a wide transmission band could be obtained, as shown in FIG. 9. The dispersion compensator of this preferred embodiment can maintain the temperature of the VIPA optical element almost constant by a temperature-controlled heater, which is not shown in FIG. 9.

If the conventional VIPA optical element that bends by λ or more, is used as a comparison target, without using the stress correction film as in FIG. 4, as in the comparison target shown in FIG. 9, the insertion loss increases and the transmission bandwidth decreases, which is a problem in the optical characteristic of the dispersion compensator.

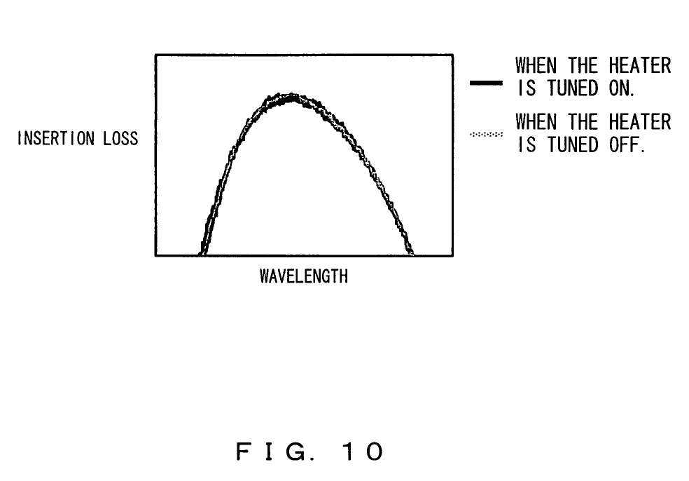

When in the dispersion compensator of this preferred embodiment, the temperature-controlled heater is turned on/off in order to maintain the temperature of the VIPA optical element almost constant, as shown in FIG. 10, there is no change in the transmission characteristic.

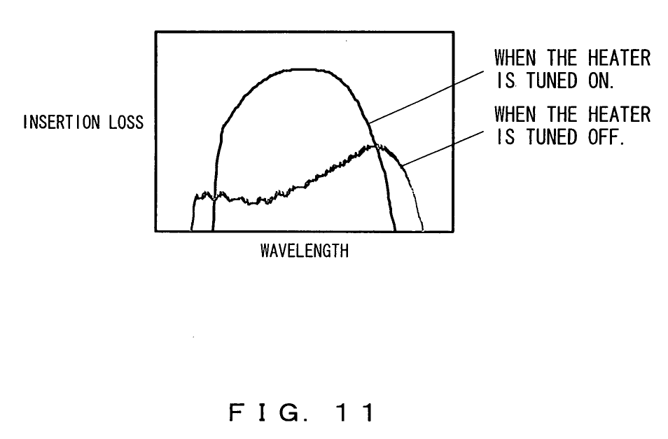

However, if the temperature-controlled heater is turned on/off when a VIPA optical element that is fixed on a plate made of SUS304 with a thermal expansion coefficient larger than that of the transparent plate, as shown in FIG. 11, there is change in the transmission characteristic.

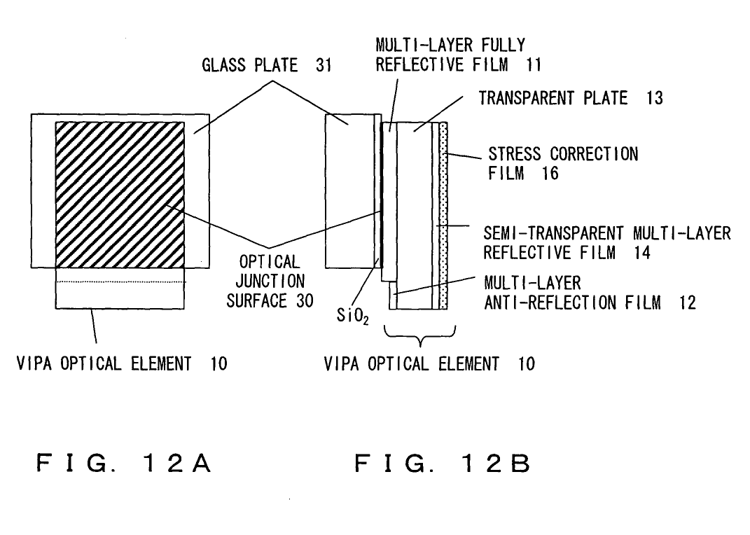

FIGS. 12A and 12B show the structure of another preferred embodiment of the present invention. FIGS. 12A and 12B are the top view and section view, respectively.

In this preferred embodiment, a flat VIPA optical element 10, having a stress correction film 16 to balance the surface film stress, is fixed on the glass plate 31 being a fixing material.

In this preferred embodiment, the thermal expansion coefficient of the plate-shaped fixing material 20 is made of the same material as that of the transparent plate using transparent optical glass (LAH78) for both the transparent plate 13 of the VIPA optical element 10 and the plate-shaped fixing material 31.

In this preferred embodiment, the material on the top surface (optical junction surface) of the multi-layer fully reflective film 11 of the VIPA optical element 10 is SiO₂, and similarly a SiO₂ film is formed on the surface of the glass plate 31 being a fixing material 20.

In this preferred embodiment, a glass plate 31 being a fixing material must be sufficiently thick and therefore difficult to deform. Simultaneously, the profile irregularity of the junction surface must be maintained at a low level, for example, λ/10 or less. By optically jointing (30) the VIPA optical element 10 with such a thick glass plate 31 with low profile irregularity while heating, the profile irregularity of the VIPA optical element 10 can be improved from λ˜λ/2 to λ/10 or less.

Since the SiO₂ film formed by an ion plating method or the like is hard to optically joint, a chemical or physical surface activation process can also be applied to the film.

In this preferred embodiment, since adhesive, such as organic adhesives or the like, is not used, there is no influence on the stress of adhesive.

A dispersion compensator is configured using the flatly-fixed VIPA optical element 10 of this preferred embodiment and a mirror reflecting and returning the spectral components of light separated by the VIPA optical element to the VIPA optical element 10, and the optical characteristic is checked by controlling heater temperature. As a result, a good optical characteristic equal to or better than that of the preferred embodiment (shown in FIG. 9) can be obtained.

As described so far, according to the present invention, by fixing a VIPA optical element in such a way as for the VIPA optical element not to bend and for its profile irregularity to be maintained at a low level, a preferable optical characteristic can be obtained in an optical device using a VIPA optical element in order to compensate for wavelength dispersion.

What is claimed is:

1. An optical device, comprising:
a substrate;
a first multi-layer film with a first refractive index, that is formed on a first surface of the substrate; a second multi-layer film with a second refractive index, that is formed on a second surface of the substrate; and
a stress correction film formed on the first or second multi-layer film, correcting the distortion of the substrate that is due to the difference in stress between the first and second multi-layer films formed on the first and second films, respectively.

2. The optical device according to claim 1, wherein said stress correction film is transparent for light with a specific wavelength, and the optical film thickness is an integral multiple of a half of the specific wavelength.

3. The optical device according to claim 1, wherein said stress correction film is made of SiO₂.

4. The optical device according to claim 1, wherein said stress correction film maintains the profile irregularity of the substrate one wavelength or less.

5. The optical device according to claim 1, comprising:
a VIPA optical element further comprising:
said substrate being a plate that is transparent for light with a specific wavelength;
said first multi-layer film;
said second multi-layer film; and
said stress correction film maintaining the VIPA optical element flat, and p1 a mirror reflecting and returning the spectral components of light separated by the VIPA optical element to the VIPA optical element, wherein
a dispersion compensator is realized by using said VIPA optical element and said mirror.

6. The optical device according to claim 1, wherein said substrate comprising said first and second multi-layer films and said stress correction film is fixed on a fixing material having almost the same thermal expansion coefficient as the substrate.

7. The optical device according to claim 6, wherein said fixing material is made of transparent glass or semiconductor.

8. The optical device according to claim 6, wherein said fixing material is made of opaque metal or ceramic.

9. The optical device according to claim 6, wherein said fixing material is made of copper-tungsten alloy, Kovar alloy, alumina or BeO.

10. The optical device according to claim 6, wherein said substrate comprising said first and second films and said stress correction film is fixed on said fixing material by organic adhesives, metallic soldering or low melting point glass.

11. The optical device according to claim 6, wherein said substrate comprising said first and second films and said stress correction film is fixed on said fixing material at a plurality of points.

12. The optical device according to claim 6, wherein said substrate comprising said first and second films and said stress correction film is optically jointed with said fixing material.

13. The optical device according to claim 12, wherein the material of the optically jointed surfaces is SiO₂.
